(19) United States
(12) Patent Application Publication
(10) Pub. No.: US 2010/0152375 A1
(43) Pub. Date: Jun. 17, 2010

(54) Thickening and Clear Aqueous Compounds, Their Use in Acid Aqueous Formulations, The Formulations Obtained

(75) Inventor: Yves Kensicher, Theize (FR)

Correspondence Address: AMSTER, ROTHSTEIN & EBENSTEIN LLP, 90 PARK AVENUE, NEW YORK, NY, 10016, US

(73) Assignee: COATEX S.A.S., Genay (FR)

(21) Appl. No.: 12/086,065

(22) PCT Filed: Dec. 13, 2006
(86) PCT No.: PCT/IB2006/003645

§ 371 Date: Sep. 8, 2009

(30) Foreign Application Priority Data
Dec. 20, 2005 (FR) 05/12929

(51) Int. Cl. C08L 75/12

(52) U.S. Cl. 524/591

(57) ABSTRACT

The invention lies in thickening and clear aqueous compounds containing at least 2 non-ionic surfactants, and at least 1 polyurethane compound consisting of at least one grouping of the alkyl or aryl or aryalkyl type, or a blend of these groupings, of at least one grouping of the polyalkylene glycol type, and of at least one isocyanate grouping chosen from among 1-decyl isocyanate, 1-dodecyl isocyanate, mirystyl isocyanate, palmityl isocyanate, stearyl isocyanate, 1,4-butane di-isocyanate, 1,6-hexane diisocyanate, the cycloaliphatic diisocyanates, isophorone diisocyanate, 1,3- and 1,4-cyclohexane diisocyanate, 4,4′ diisocyanatodicyclohexylmethane, 1-methyl-2,4-diisocyanatocyclohexane and its blend with 1-methyl-2,6-diisocyanatocyclohexane, hexamethylene diisocyanate biuret, hexamethylene diisocyanate trimer, isophorone diisocyanate trimer, and their blends.

The invention also consists in their use to thicken acidic aqueous formulations, whilst maintaining their clear character. Clear acidic aqueous formulations thickened in this manner constitute a final object of the invention.

The technical field of the present invention consists of aqueous formulations called “acid” formulations (acid is in this context taken to mean strictly having a pH of under 7), such as notably for detergency, scale elimination, and cosmetic applications where a pH of under 7 is required.

A first object of the invention consists of thickening and clear aqueous compounds containing:
(a) at least 2 non-ionic surfactants,
(b) at least 1 polyurethane compound, consisting of at least one grouping of the alkyl or aryl or aryalkyl type, or a blend of these groupings, of at least one grouping of the polyalkylene glycol type, which is preferentially polyethylene glycol, and at least one particular isocyanate grouping as explained below in the present application,
(c) and water.

Another object of the invention is the use of such compounds with a view to thickening acidic aqueous formulations whilst maintaining their clear character.

A final object of the invention lies in clear and thus thickened acidic aqueous formulations.

In the sector of aqueous formulations, it is a well known requirement to thicken the said formulations (i.e. to increase their viscosity) for their satisfactory applicability when they are used by the end user.

To do so, the skilled man in the art (the formulator of such formulations) has for many years developed rheology modifying additives, the main effect of which is that of thickening the formulations which he manufactures; these additives bear the name of thickening agents, whether of natural or synthetic origin.

In the more restricted field with which the present invention is concerned, i.e. so-called acidic (pH<7) aqueous formulations, the use of traditional acrylic thickening agents is clearly impossible since it is known that the latter are ineffective at such pH values.

Use is therefore made of other types of thickening agents, including notably polyurethanes, although others also exist.

Thus, the skilled man in the art is familiar with xanthane-based thickening agents, which are relatively effective in terms of thickening power, but which nevertheless pose two major problems.

The first is that they are presented in the form of a dry powder, which powder must previously be dispersed in an aqueous medium, which constitutes an additional stage for its use, and thus an additional cost and additional investments, in addition to the fact that the skilled man in the art or the end user must choose the ad hoc dispersant to accomplish this dispersion.

The second is that, for household applications, such as scale elimination of domestic appliances, it is a prohibitive argument against this type of thickening agent: in an aqueous medium, they produce a cloudy solution which is completely opposed to the expectation of the end user, in terms of presentation and packaging.

The skilled man in the art is also familiar with the use of blends of the quaternary amine type with different surfactants. However, it must be stressed that their effectiveness is reliant on an often difficult adjustment of the amine/surfactant pair. But the main argument against them is an environmental one: their cationic nature predisposes them to be adsorbed on anionic bodies (such as, notably, fish gills), making them lethal dangers for aquatic fauna.

Consequently, the skilled man in the art resolutely turns to thickening agents of the polyurethane type.

In order to be used, such thickening agents of the polyurethane type must be solubilised; the skilled man in the art then turns to the use of solutions which consist of the use of additives which are often given the name of surfactants. The Applicant indicates that then the compounds thus formulated can lead to problems of clearness, as in the case of xanthane compounds.

As such, the skilled man in the art is familiar with document EP 1 093 488, which concerns the technical problem of producing highly concentrated thickening associative polymers without using solvents, and using a small quantity of rheology modifiers. This document describes the use of a non-ionic surfactant of formula RO—(-AO—)ₐ—H, where R designates an alkyl group having 6 to 12 carbon atoms, and AO designates an oxyethylene or oxypropylene group (in a ratio between the number of oxyethylene:oxypropylene groups of between 1:2 and 5:6) with “a” between 7 and 16, as an agent strongly reducing the viscosity of an aqueous concentrate of an associative thickening polymer, of the polyurethane type. It also describes an aqueous concentrate having 10% to 50% by weight of polyurethane, and 1% to 25% by weight of surfactant. These formulations are particularly suitable in applications of the paint and varnish type containing latex.

The skilled man in the art is also familiar with document EP 0 839 877, which seeks to resolve the problem of the preparation of thickening agents which have, firstly, a reduced viscosity, but also have improved rheological properties. This document describes a preparation for a thickening agent for adjustment of the rheology of aqueous systems consisting of urethane-based thickening agents, of a non-ionic surfactant and of a third additive (diester).

He is also familiar with document EP 0 682 094, the purpose of which consists in eliminating the solvent phase, which enables polyurethane to be formulated in a liquid and usable form. To this end, it describes an associative thickening compound for controlling the rheology of aqueous systems, where this thickening formulation has a viscosity of less than 15,000 mPa·s and consists, in terms of the percentage by weight of each constituent, of: 15% to 40% of a thickening polymer (such as a polyurethane), at least 30% of water and of 1% to 30% of one or more anionic and/or non-ionic surfactants.

He is also familiar with document EP 0 835 291, which concerns the preparation of a polyurethane base in a liquid form to prepare an aqueous formulation of a water-soluble thickening agent (including urethane groups), by using an agent to reduce viscosity, where the said agent is a surfactant containing oxyalkylene units having 2 to 4 carbon atoms and a hydrocarbonated radical. This document describes formulations constituted, expressed as a percentage by weight of each constituent, of 1% to 50% of surfactant, of 10% to 99% of thickening agent, and the remainder of water.

None of these documents concerns the technical problem of the invention, i.e. the preparation of thickening agents specifically for acidic formulations.

Finally, the skilled man in the art is familiar with document EP 0 875 557, which described an aqueous compound of an associative thickening agent of the polyetherurethane type, formulated with a blend of at least 2 ionic or non-ionic surfactants of different (a condition in relation to the value of the HLB and of the mass ratio between the surfactants of the blend) HLB (hydrophile-lipophile balance) to improve the thickening of the formulations containing this compound, whilst reducing the polyurethane concentration. The applications targeted are extremely broad, and the very great majority do not concern the treatment of acidic systems (page 2 lines 50-56), except for a brief mention of an acidic formulation for hygiene (page 2 line 55). It is indicated that such a compound may nonetheless be used in an acidic formulation containing between 5% and 10% by weight of phosphoric, sulphuric or citric acid, in a very general fashion (page 13, lines 46-49).

This document is, therefore, not specially suitable for the treatment of acidic formulations, and there is no objective reason why the skilled man in the art should observe and isolate the acidic formulation for hygiene in the midst of some twelve other non-acidic applications, such as boring fluids, paints, coverings, and various lotions for shampoo and similar, or for agriculture and pesticide formulations.

Thus, with a view to resolving the general technical problem of increasing the viscosity of acidic aqueous formulations, whilst preventing the disadvantages relating to the use of xanthanes (dry powders which must firstly be solubilised, and which then lead to cloudy formulations), and quaternary amines (products which are dangerous for aquatic fauna), the skilled man in the art has used, in a surprising manner, new thickening and clear compounds containing:
(a) at least 2 non-ionic surfactants,
(b) at least 1 polyurethane compound, consisting of at least one grouping of the alkyl or aryl or aryalkyl type, or a blend of these groupings, of at least one grouping of the polyalkylene glycol type, which is preferentially polyethylene glycol, and at least one particular isocyanate grouping chosen from among:
   the monoisocyanates, and notably 1-decyl isocyanate, 1-dodecyl isocyanate, mirystyl isocyanate, palmityl isocyanate, stearyl isocyanate,
   the diisocyanates, and notably 1,4-butane di-isocyanate, 1,6-hexane diisocyanate, the cycloaliphatic diisocyanates, and notably isophorone diisocyanate, 1,3- and 1,4-cyclohexane diisocyanate, 4,4′diisocyanatodicyclohexylmethane, 1-methyl-2,4-diisocyanatocyclohexane and its blend with 1-methyl-2,6-diisocyanatocyclohexane,
   the triisocyanates, and notably hexamethylene diisocyanate biuret, hexamethylene diisocyanate trimer, isophorone diisocyanate trimer,
   and their blends,
(c) and water.

In a completely surprising manner, these compounds prove to be completely clear, and enable thickened acidic aqueous formulations to be produced which are themselves also perfectly clear, which was not the case with all the polyurethane compounds of the prior art.

In addition, such compounds enable the acidic aqueous formulations containing them to be thickened very substantially, and more effectively than the polyurethane compounds of the prior art.

To resolve the general problem of the increase of viscosity whilst retaining a clear character both in the thickening compound and in the thickened acidic aqueous formulation, the Applicant was able to observe that to attain their goal it was necessary to solubilise the polyurethane compound very thoroughly.

The Applicant's merit lies notably in the development of blends of at least 2 surfactants and at least one particular polyurethane compound as described below in the present application. Here the surfactant/polyurethane pairs are such that the surfactants solubilise perfectly these polyurethanes in water which, according to the Applicant's research, enables, in a surprising manner, a product to be obtained which is very effective in terms of its thickening effect, whilst retaining a clear character in the thickening compound and in the thickened acidic aqueous formulation.

Consequently, cloudy solutions are not produced (as with xanthanes and certain polyurethane blends of the prior art), there are no environmental dangers (unlike with quaternary amines or with solvents), and the technique is very simple to use (no problems of powders as with xanthanes). In addition, the thickening effect obtained is very substantial.

Thus, a first object of the invention consists of thickening and clear aqueous compounds containing:
(a) at least 2 non-ionic surfactants,
(b) at least 1 polyurethane compound, consisting of at least one grouping of the alkyl or aryl or aryalkyl type, or a blend of these groupings, of at least one grouping of the polyalkylene glycol type, which is preferentially polyethylene glycol, and at least one particular isocyanate grouping chosen from among:
   the monoisocyanates, and notably 1-decyl isocyanate, 1-dodecyl isocyanate, mirystyl isocyanate, palmityl isocyanate, stearyl isocyanate,
   the diisocyanates, and notably 1,4-butane di-isocyanate, 1,6-hexane diisocyanate, the cycloaliphatic diisocyanates, and notably isophorone diisocyanate, 1,3- and 1,4-cyclohexane diisocyanate, 4,4′ diisocyanatodicyclohexylmethane, 1-methyl-2,4-diisocyanatocyclohexane and its blend with 1-methyl-2,6-diisocyanatocyclohexane,
   the triisocyanates, and notably hexamethylene diisocyanate biuret, hexamethylene diisocyanate trimer, isophorone diisocyanate trimer,
   and their blends,
(c) and water.

These thickening and clear aqueous compounds are also characterised in that they contain, expressed as a percentage by weight of each constituent, relative to the total weight of the formulation:
(a) between 10% and 80%, and preferentially between 20% and 65%, of at least 2 non-ionic surfactants,
(b) between 4% and 40%, and preferentially between 10% and 30%, of at least 1 polyurethane compound, consisting of at least one grouping of the alkyl or aryl or aryalkyl type, or a blend of these groupings, of at least one grouping of the polyalkylene glycol type, which is preferentially polyethylene glycol, and of at least one isocyanate grouping chosen from among:
   the monoisocyanates, and notably 1-decyl isocyanate, 1-dodecyl isocyanate, mirystyl isocyanate, palmityl isocyanate, stearyl isocyanate,
   the diisocyanates, and notably 1,4-butane di-isocyanate, 1,6-hexane diisocyanate, the cycloaliphatic diisocyanates, and notably isophorone diisocyanate, 1,3- and 1,4-cyclohexane diisocyanate, 4,4′ diisocyanatodicyclohexylmethane, 1-methyl-2,4-diisocyanatocyclohexane and its blend with 1-methyl-2,6-diisocyanatocyclohexane,
   the triisocyanates, and notably hexamethylene diisocyanate biuret, hexamethylene diisocyanate trimer, isophorone diisocyanate trimer,
   and their blends,
(c) and the remainder of water.

These thickening and clear aqueous compounds are also characterised in that, in respect of the surfactants they use, the said surfactants are non-ionic oxyalkylated fatty alcohols, preferentially having 3 to 40 oxyethylene units, and preferentially having 8 to 30 carbon atoms, and very preferentially 8 to 20 carbon atoms.

These thickening and clear aqueous compounds are also characterised in that, in respect of the polyurethanes which they use, the groupings of the alkyl or aryl or aryalkyl type, of a blend of these groupings, are preferentially fatty alcohols, with these fatty alcohols preferentially having 8 to 20 carbon atoms, very preferentially 10 to 18 carbon atoms, and extremely preferentially 10 to 16 carbon atoms.

These thickening and clear aqueous compounds are also characterised in that, in respect of the polyurethanes which they use, the polyalkylene glycol groupings have a molecular weight of between 5,000 g/mole and 20,000 g/mole, and preferentially between 8,000 g/mole and 15,000 g/mole, and very preferentially between 8,000 g/mole and 12,000 g/mole.

The Applicant indicates that in the present Application the molecular weight of the polymers used is determined using the GPC (Gel Permeability Chromatography) method, using a liquid chromatography device of Waters™ brand fitted with two detectors, one of which combines dynamic diffusion of light with viscometry measured using a Viscotek™ viscometer, the other being a detector of refractometric concentration of Waters™ brand.

This liquid chromatography equipment is fitted with steric exclusion columns suitably chosen by the skilled man in the art in order to separate the different molecular weights of the polymers studied.

The elution liquid phase is an aqueous phase.

These thickening and clear aqueous compounds are also characterised in that, in respect of the polyurethanes which they use, the isocyanate groupings are chosen from among the diisocyanates, and notably 1,4-butane di-isocyanate, 1,6-hexane diisocyanate, the cycloaliphatic diisocyanates, and notably isophorone diisocyanate, 1,3- and 1,4-cyclohexane diisocyanate, 4,4′ diisocyanatodicyclohexylmethane, 1-methyl-2,4-diisocyanatocyclohexane and its blends with 1-methyl-2,6-diisocyanatocyclohexane and their blends, and preferentially in that the isocyanate grouping is isophorone diisocyanate.

A second object of the invention consists in the use, in order to thicken acidic aqueous formulations and to retain their clearness, of thickening and clear aqueous compounds containing:
(a) at least 2 non-ionic surfactants,
(b) at least 1 polyurethane compound, consisting of at least one grouping of the alkyl or aryl or aryalkyl type, or a blend of these groupings, of at least one grouping of polyalkylene glycol which is preferentially polyethylene glycol, and at least one particular isocyanate grouping chosen from among:
   the monoisocyanates, and notably 1-decyl isocyanate, 1-dodecyl isocyanate, mirystyl isocyanate, palmityl isocyanate, stearyl isocyanate,
   the diisocyanates, and notably 1,4-butane di-isocyanate, 1,6-hexane diisocyanate, the cycloaliphatic diisocyanates, and notably isophorone diisocyanate, 1,3- and 1,4-cyclohexane diisocyanate, 4,4′ diisocyanatodicyclohexylmethane, 1-methyl-2,4-diisocyanatocyclohexane and its blend with 1-methyl-2,6-diisocyanatocyclohexane,
   the triisocyanates, and notably hexamethylene diisocyanate biuret, hexamethylene diisocyanate trimer, isophorone diisocyanate trimer,
   and their blends,
(c) and water.

This use is also characterised in that the said thickening and clear aqueous compounds contain, expressed as a percentage by weight of each constituent, relative to the total weight of the formulation:
(a) between 10% and 80%, and preferentially between 20% and 65%, of at least 2 non-ionic surfactants,
(b) between 4% and 40%, and preferentially between 10% and 30%, of at least 1 polyurethane compound, consisting of at least one grouping of the alkyl or aryl or aryalkyl type, or a blend of these groupings, of at least one grouping of the polyalkylene glycol type, which is preferentially polyethylene glycol, and of at least one isocyanate grouping chosen from among:
   the monoisocyanates, and notably 1-decyl isocyanate, 1-dodecyl isocyanate, mirystyl isocyanate, palmityl isocyanate, stearyl isocyanate,
   the diisocyanates, and notably 1,4-butane di-isocyanate, 1,6-hexane diisocyanate, the cycloaliphatic diisocyanates, and notably isophorone diisocyanate, 1,3- and 1,4-cyclohexane diisocyanate, 4,4′ diisocyanatodicyclohexylmethane, 1-methyl-2,4-diisocyanatocyclohexane and its blend with 1-methyl-2,6-diisocyanatocyclohexane,
   the triisocyanates, and notably hexamethylene diisocyanate biuret, hexamethylene diisocyanate trimer, isophorone diisocyanate trimer,
   and their blends,
(c) and the remainder of water.

This use is also characterised in that the thickening and clear aqueous compositions contain at least 2 surfactants which are non-ionic oxyalkylated fatty alcohols, preferentially having 3 to 40 oxyethylene units, and preferentially having 8 to 30 carbon atoms, and very preferentially 8 to 20 carbon atoms.

This use is also characterised in that the thickening and clear aqueous compounds contain at least one polyurethane compound, the groupings of which of the alkyl or aryl or aryalkyl type, or a blend of these groupings, are preferentially fatty alcohols, with these fatty alcohols preferentially having 8 to 20 carbon atoms, very preferentially 10 to 18 carbon atoms, and extremely preferentially 10 to 16 carbon atoms.

This use is also characterised in that the thickening and clear aqueous compounds contain at least one polyurethane compound the polyalkylene glycol groupings of which have a molecular weight of between 5,000 g/mole and 20,000 g/mole, and preferentially between 8,000 g/mole and 15,000 g/mole, and very preferentially between 8,000 g/mole and 12,000 g/mole.

This use is also characterised in that the thickening and clear aqueous compounds contain at least one polyurethane compound, the isocyanate groupings of which are chosen from among the diisocyanates, and notably 1,4-butane di-isocyanate, 1,6-hexane diisocyanate, the cycloaliphatic diisocyanates, and notably isophorone diisocyanate, 1,3- and 1,4-cyclohexane diisocyanate, 4,4′ diisocyanatodicyclohexylmethane, 1-methyl-2,4-diisocyanatocyclohexane and its blend with 1-methyl-2,6-diisocyanatocyclohexane and their blends, and preferentially in that the isocyanate grouping is isophorone diisocyanate.

This use is also characterised in that use is made of between 2% and 50%, and preferentially between 4% and 20%, by weight of thickening and clear aqueous compound, relative to the total weight of the acidic aqueous formulation to be thickened.

This use is also characterised in that the thickening and clear aqueous compound is used in an acidic aqueous formation containing at least one acidifier compound chosen notably from among the hydrochloric, phosphoric, sulphuric, nitric, sulphamic, acetic, boric, citraconic, citric, diglycolic, ethylene diamine tetra-acetic, hydrofluoric, formic, glucoheptonic, glutaric, glycolic, glyoxylic, isethionic, itaconic, lactic, maleic, malic, methane sulphonic, methylsuccinic, octylic, oxalic, peracetic, propionic, saccharic, succinic or valeric acids, or from among the phosphonic acids such as notably 1-hydroxyethane 1,1-diphosphonic acid, amino trimethylene phosphonic acid, ethylene diamine tetramethyl phosphonic acid, diethylene triamine pentamethyl phosphonic acid, hexamethylene diamine tetramethyl phosphonic acid, hydroxyethylamino dimethyl phosphonic acid, 2-phosphonobutane-1,2,4-tricarboxylic acid, or the blends of these acids, or again the blends of these acids with oxygenated water.

However, this list is not exhaustive.

This use is also characterised in that the thickening and clear aqueous compound is used in an acidic aqueous formulation, the pH of which is less than 7, preferentially less than 6, very preferentially less than 5, and even more preferentially less than 4.

A final object of the invention lies in the acidic aqueous formulations thus thickened, the appearance of which is clear.

The invention will be better understood on reading the descriptions which follow, and the non-limitative examples below.

### EXAMPLES

### Example 1

This example illustrates the use of a thickening aqueous compound according to the invention or according to the prior art, with a view to thickening an acidic aqueous formulation containing citric acid.

This example also illustrates the thickening aqueous compounds according to the invention, and the acidic aqueous formulations according to the invention.

For each of the tests No. 1 to 16, one commences by evaluating visually the clear or cloudy character of each thickening compound, and of each acidic aqueous formulation. Lastly, the Brookfield™ viscosity of each acidic aqueous formulation is measured, at 25° C. and at 20 rpm with module No. 3 (according to the method well known to the skilled man in the art).

The ratio R between this viscosity and the mass percentage of the thickening aqueous compound introduced into the acidic aqueous formulation to be thickened is then calculated.

### Test No. 1

This test illustrates the prior art.

Thickening Compound
The test uses a thickening compound consisting of, expressed as a percentage by weight of the constituents relative to the total weight of the compound:
   10% of a polyurethane thickening agent consisting, expressed as a percentage by weight of the different monomers relative to the total weight of the polymer, of:
      87.0% of polyethylene glycol of molecular weight equal to 5,500 g/mole,
      6.3% of di-isocyanate toluene,
      6.7% of a linear alcohol having 12 carbon atoms,
      90% of an aqueous solution at 28% by dry weight of lauryl ether sulphate.
This thickening compound thus uses a polyurethane thickening agent and a surfactant which cannot be included in the present invention.
The thickening compound thus produced is cloudy.

Acidic Aqueous Formulation
This thickening compound is used to thicken an acidic aqueous formulation, which contains, expressed as a percentage by weight of the constituents relative to the total weight of the formulation:
   3% of citric acid,
   14% of the above-mentioned thickening compound,
   83% of water in addition to the water already present in the thickening compound.

The pH of the acidic aqueous formulation is less than 2.

The acidic aqueous formulation thus produced proves to be cloudy.

### Test No. 2

This test illustrates the prior art.

Thickening Compound
The test uses a thickening compound consisting of, expressed as a percentage by weight of the constituents relative to the total weight of the compound:
   10% of a polyurethane thickening agent consisting, expressed as a percentage by weight of the different monomers relative to the total weight of the polymer, of:
      87.0% of polyethylene glycol of molecular weight equal to 5,500 g/mole,
      6.3% of di-isocyanate toluene,
      6.7% of a linear alcohol having 12 carbon atoms,
   90% of a blend of 2 fatty alcohols having 14 and 15 carbon atoms, and having 8 oxyethylene units,
This thickening compound thus uses a polyurethane thickening agent which cannot be included in the present invention, and a surfactant which can be included in the present invention.
The thickening compound thus produced is cloudy.

Acidic Aqueous Formulation
This thickening compound is used to thicken an acidic aqueous formulation, which contains, expressed as a percentage by weight of the constituents relative to the total weight of the formulation:
   3% of citric acid,
   14.2% of the above-mentioned thickening compound,
   82.8% of water in addition to the water already present in the thickening compound.

The pH of the acidic aqueous formulation is less than 2.

The acidic aqueous formulation thus produced proves to be cloudy.

### Test No. 3

This test illustrates the prior art.

Thickening Compound
The test uses a thickening compound consisting of, expressed as a percentage by weight of the constituents relative to the total weight of the formulation:
   10% of a polyurethane thickening agent consisting, expressed as a percentage by weight of the different monomers relative to the total weight of the polymer, of:
      69.4% of polyethylene glycol of molecular weight equal to 10,000 g/mole,
      5.3% isophorone di-isocyanate,
      25.3% of a linear alcohol having 12 carbon atoms,
   90% of an aqueous solution at 28% by dry weight of lauryl ether sulphate
This thickening compound thus uses a polyurethane thickening agent which can be included in the present invention, and a surfactant which cannot be included in the present invention.
The thickening compound thus produced is cloudy.

Acidic Aqueous Formulation
This thickening compound is used to thicken an acidic aqueous formulation, which contains, expressed as a percentage by weight of the constituents relative to the total weight of the formulation:
   3% of citric acid,
   13.6% of the above-mentioned thickening compound,
   83.4% of water in addition to the water already present in the thickening compound.

The pH of the acidic aqueous formulation is less than 2.

The acidic aqueous formulation thus produced proves to be cloudy.

### Test No. 4

This test illustrates the prior art.

Thickening Formulation
The test uses a thickening compound consisting of, expressed as a percentage by weight of the constituents relative to the total weight of the compound:
   17.65% of a polyurethane thickening agent consisting, expressed as a percentage by weight of the different monomers relative to the total weight of the polymer, of:
      87.0% of polyethylene glycol of molecular weight equal to 5,500 g/mole,
      6.3% of di-isocyanate toluene,
      6.7% of a linear alcohol having 12 carbon atoms,
   15.90% by weight of water,
   21.99% by weight of an ethoxylated non-ionic surfactant which is a blend of fatty alcohols having 12 to 18 carbon atoms on the fatty chain, and comprising 7 ethylene oxide units,
   4.44% by weight of an ethoxylated non-ionic surfactant which is a blend of fatty alcohols having 12 to 18 carbon atoms on the fatty chain, and comprising 3 ethylene oxide units,
   40.02% by weight of an ethoxylated non-ionic surfactant which is a blend of fatty alcohols having 8 carbon atoms on the fatty chain, and comprising 35 ethylene oxide units,
This thickening compound thus uses a polyurethane thickening agent which cannot be included in the present invention, and a surfactant which can be included in the present invention.
The thickening compound thus produced is cloudy.

Acidic Aqueous Formulation
This thickening compound is used to thicken an acidic aqueous formulation, which contains, expressed as a percentage by weight of the constituents relative to the total weight of the formulation:
   3% of citric acid,
   10.4% of the above-mentioned thickening compound,
   86.6% of water in addition to the water already present in the thickening compound.

The pH of the acidic aqueous formulation is less than 2.

The acidic aqueous formulation thus produced proves to be cloudy.

### Test No. 5

This test illustrates the invention.

Thickening Compound
The test uses a thickening compound consisting of, expressed as a percentage by weight of the constituents relative to the total weight of the compound:
   17.65% of a polyurethane thickening agent consisting, expressed as a percentage by weight of the different monomers relative to the total weight of the polymer, of:
      69.4% of polyethylene glycol of molecular weight equal to 5,500 g/mole,
      5.3% isophorone di-isocyanate,
      25.3% of a linear alcohol having 12 carbon atoms,
   15.90% by weight of water,
   21.99% by weight of an ethoxylated non-ionic surfactant which is a blend of fatty alcohols having 12 to 18 carbon atoms on the fatty chain, and comprising 7 ethylene oxide units,
   4.44% by weight of an ethoxylated non-ionic surfactant which is a blend of fatty alcohols having 12 to 18 carbon atoms on the fatty chain, and comprising 3 ethylene oxide units,
   40.02% by weight of an ethoxylated non-ionic surfactant which is a blend of fatty alcohols having 8 carbon atoms on the fatty chain, and comprising 35 ethylene oxide units,
The thickening compound thus produced is clear.

Acidic Aqueous Formulation
This thickening compound is used to thicken an acidic aqueous formulation, which contains, expressed as a percentage by weight of the constituents relative to the total weight of the formulation:
   3% of citric acid,
   9.1% of the above-mentioned thickening compound,
   87.9% of water in addition to the water already present in the thickening compound.

The pH of the acidic aqueous formulation is less than 2.

The acidic aqueous formulation thus produced proves to be clear.

### Test No. 6

This test illustrates the invention.

Thickening Compound
The test uses a thickening compound consisting of, expressed as a percentage by weight of the constituents relative to the total weight of the compound:
   17.65% of a polyurethane thickening agent consisting, expressed as a percentage by weight of the different monomers relative to the total weight of the polymer, of:
      69.4% of polyethylene glycol of molecular weight equal to 8,000 g/mole,
      5.3% isophorone di-isocyanate,
      25.3% of a linear alcohol having 12 carbon atoms,
   15.90% by weight of water,
   21.99% by weight of an ethoxylated non-ionic surfactant which is a blend of fatty alcohols having 12 to 18 carbon atoms on the fatty chain, and comprising 7 ethylene oxide units,
   4.44% by weight of an ethoxylated non-ionic surfactant which is a blend of fatty alcohols having 12 to 18 carbon atoms on the fatty chain, and comprising 3 ethylene oxide units,
   40.02% by weight of an ethoxylated non-ionic surfactant which is a blend of fatty alcohols having 8 carbon atoms on the fatty chain, and comprising 35 ethylene oxide units,
The thickening compound thus produced is clear.

Acidic Aqueous Formulation
This thickening compound is used to thicken an acidic aqueous formulation, which contains, expressed as a percentage by weight of the constituents relative to the total weight of the formulation:
   3% of citric acid,
   9.1% of the above-mentioned thickening compound,
   87.9% of water in addition to the water already present in the thickening compound.

The pH of the acidic aqueous formulation is less than 2.

The acidic aqueous formulation thus produced proves to be clear.

### Test No. 7

This test illustrates the invention.

Thickening Compound
The test uses a thickening compound consisting of, expressed as a percentage by weight of the constituents relative to the total weight of the compound:
   17.65% of a polyurethane thickening agent consisting, expressed as a percentage by weight of the different monomers relative to the total weight of the polymer, of:
      69.4% of polyethylene glycol of molecular weight equal to 10,000 g/mole,
      5.3% isophorone di-isocyanate,
      25.3% of a linear alcohol having 12 carbon atoms,
   15.90% by weight of water,
   21.99% by weight of an ethoxylated non-ionic surfactant which is a blend of fatty alcohols having 12 to 18 carbon atoms on the fatty chain, and comprising 7 ethylene oxide units,
   4.44% by weight of an ethoxylated non-ionic surfactant which is a blend of fatty alcohols having 12 to 18 carbon atoms on the fatty chain, and comprising 3 ethylene oxide units,
   40.02% by weight of an ethoxylated non-ionic surfactant which is a blend of fatty alcohols having 8 carbon atoms on the fatty chain, and comprising 35 ethylene oxide units.
The thickening compound thus produced is clear.

Acidic Aqueous Formulation
This thickening compound is used to thicken an acidic aqueous formulation, which contains, expressed as a percentage by weight of the constituents relative to the total weight of the formulation:
   3% of citric acid,
   9.1% of the above-mentioned thickening compound,
   87.9% of water in addition to the water already present in the thickening compound.

The pH of the acidic aqueous formulation is less than 2.

The acidic aqueous formulation thus produced proves to be clear.

### Test No. 8

This test illustrates the invention.

Thickening Compound
The test uses a thickening compound consisting of, expressed as a percentage by weight of the constituents relative to the total weight of the compound:
   17.65% of a polyurethane thickening agent consisting, expressed as a percentage by weight of the different monomers relative to the total weight of the polymer, of:
      88.5% of polyethylene glycol of molecular weight equal to 10,000 g/mole,
      5.4% isophorone di-isocyanate,
      6.1% of a blend of linear alcohols having 12 and 13 carbon atoms,
   15.90% by weight of water,
   21.99% by weight of an ethoxylated non-ionic surfactant which is a blend of fatty alcohols having 12 to 18 carbon atoms on the fatty chain, and comprising 7 ethylene oxide units,
   4.44% by weight of an ethoxylated non-ionic surfactant which is a blend of fatty alcohols having 12 to 18 carbon atoms on the fatty chain, and comprising 3 ethylene oxide units,
   40.02% by weight of an ethoxylated non-ionic surfactant which is a blend of fatty alcohols having 8 carbon atoms on the fatty chain, and comprising 35 ethylene oxide units.
The thickening compound thus produced is clear.

Acidic Aqueous Formulation
This thickening compound is used to thicken an acidic aqueous formulation, which contains, expressed as a percentage by weight of the constituents relative to the total weight of the formulation:
   3% of citric acid,
   9.1% of the above-mentioned thickening compound,
   87.9% of water in addition to the water already present in the thickening compound.

The pH of the acidic aqueous formulation is less than 2.

The acidic aqueous formulation thus produced proves to be clear.

### Test No. 9

This test illustrates the invention.

Thickening Compound
The test uses a thickening compound consisting of, expressed as a percentage by weight of the constituents relative to the total weight of the compound:
   17.65% of a polyurethane thickening agent consisting, expressed as a percentage by weight of the different monomers relative to the total weight of the polymer, of
      87.2% of polyethylene glycol of molecular weight equal to 10,000 g/mole,
      6.6% isophorone di-isocyanate,
      6.2% of a blend of linear alcohols having 12, 13, 14 and 15 carbon atoms,
   15.90% by weight of water,
   21.99% by weight of an ethoxylated non-ionic surfactant which is a blend of fatty alcohols having 12 to 18 carbon atoms on the fatty chain, and comprising 7 ethylene oxide units,
   4.44% by weight of an ethoxylated non-ionic surfactant which is a blend of fatty alcohols having 12 to 18 carbon atoms on the fatty chain, and comprising 3 ethylene oxide units,
   40.02% by weight of an ethoxylated non-ionic surfactant which is a blend of fatty alcohols having 8 carbon atoms on the fatty chain, and comprising 35 ethylene oxide units.
The thickening compound thus produced is clear.

Acidic Aqueous Formulation
This thickening compound is used to thicken an acidic aqueous formulation, which contains, expressed as a percentage by weight of the constituents relative to the total weight of the formulation:
   3% of citric acid,
   9.1% of the above-mentioned thickening compound,
   87.9% of water in addition to the water already present in the thickening compound.

The pH of the acidic aqueous formulation is less than 2.

The acidic aqueous formulation thus produced proves to be clear.

### Test No. 10

This test illustrates the invention.

Thickening Compound
The test uses a thickening compound consisting of, expressed as a percentage by weight of the constituents relative to the total weight of the compound:
   17.65% of a polyurethane thickening agent consisting, expressed as a percentage by weight of the different monomers relative to the total weight of the polymer, of:
      88.2% of polyethylene glycol of molecular weight equal to 10,000 g/mole,
      6.0% isophorone di-isocyanate,
      5.8% of a linear alcohol having 14 carbon atoms,
   15.90% by weight of water,
   21.99% by weight of an ethoxylated non-ionic surfactant which is a blend of fatty alcohols having 12 to 18 carbon atoms on the fatty chain, and comprising 7 ethylene oxide units,
   4.44% by weight of an ethoxylated non-ionic surfactant which is a blend of fatty alcohols having 12 to 18 carbon atoms on the fatty chain, and comprising 3 ethylene oxide units,
   40.02% by weight of an ethoxylated non-ionic surfactant which is a blend of fatty alcohols having 8 carbon atoms on the fatty chain, and comprising 35 ethylene oxide units.
The thickening compound thus produced is clear.

Acidic Aqueous Formulation
This thickening compound is used to thicken an acidic aqueous formulation, which contains, expressed as a percentage by weight of the constituents relative to the total weight of the formulation:
   3% of citric acid,
   5.7% of the above-mentioned thickening compound,
   91.3% of water in addition to the water already present in the thickening compound.

The pH of the acidic aqueous formulation is less than 2.

The acidic aqueous formulation thus produced proves to be clear.

### Test No. 11

This test illustrates the invention.

Thickening Compound
The test uses a thickening compound consisting of, expressed as a percentage by weight of the constituents relative to the total weight of the compound:
   17.65% of a polyurethane thickening agent consisting, expressed as a percentage by weight of the different monomers relative to the total weight of the polymer, of:
      88.2% of polyethylene glycol of molecular weight equal to 10,000 g/mole,
      6.0% isophorone di-isocyanate,
      5.8% of a linear alcohol having 14 carbon atoms,
   15.90% by weight of water,
   21.99% by weight of an ethoxylated non-ionic surfactant which is a blend of fatty alcohols having 12 to 18 carbon atoms on the fatty chain, and comprising 7 ethylene oxide units,
   4.44% by weight of an ethoxylated non-ionic surfactant which is a blend of fatty alcohols having 12 to 18 carbon atoms on the fatty chain, and comprising 3 ethylene oxide units,
   40.02% by weight of an ethoxylated non-ionic surfactant which is a blend of fatty alcohols having 8 carbon atoms on the fatty chain, and comprising 35 ethylene oxide units.
The thickening compound thus produced is clear.

Acidic Aqueous Formulation
This thickening compound is used to thicken an acidic aqueous formulation, which contains, expressed as a percentage by weight of the constituents relative to the total weight of the formulation:
   3% of citric acid,
   4.35% of the above-mentioned thickening compound,
   92.65% of water in addition to the water already present in the thickening compound.

The pH of the acidic aqueous formulation is less than 2.

The acidic aqueous formulation thus produced proves to be clear.

### Test No. 12

This test illustrates the invention.

Thickening Compound
The test uses a thickening compound consisting of, expressed as a percentage by weight of the constituents relative to the total weight of the compound:
   17.65% of a polyurethane thickening agent consisting, expressed as a percentage by weight of the different monomers relative to the total weight of the polymer, of:
      88.2% of polyethylene glycol of molecular weight equal to 10,000 g/mole,
      6.0% isophorone di-isocyanate,
      5.8% of a linear alcohol having 14 carbon atoms,
   15.90% by weight of water,
   21.99% by weight of an ethoxylated non-ionic surfactant which is a blend of fatty alcohols having 12 to 18 carbon atoms on the fatty chain, and comprising 7 ethylene oxide units,
   4.44% by weight of an ethoxylated non-ionic surfactant which is a blend of fatty alcohols having 12 to 18 carbon atoms on the fatty chain, and comprising 3 ethylene oxide units,
   40.02% by weight of an ethoxylated non-ionic surfactant which is a blend of fatty alcohols having 8 carbon atoms on the fatty chain, and comprising 35 ethylene oxide units.
The thickening compound thus produced is clear.

Acidic Aqueous Formulation
This thickening compound is used to thicken an acidic aqueous formulation, which contains, expressed as a percentage by weight of the constituents relative to the total weight of the formulation:
   3% of citric acid,
   4.4% of the above-mentioned thickening compound,
   92.6% of water in addition to the water already present in the thickening compound.

The pH of the acidic aqueous formulation is less than 2.

The acidic aqueous formulation thus produced proves to be clear.

### Test No. 13

This test illustrates the invention.

Thickening Compound
The test uses a thickening compound consisting of, expressed as a percentage by weight of the constituents relative to the total weight of the compound:
   17.65% of a polyurethane thickening agent consisting, expressed as a percentage by weight of the different monomers relative to the total weight of the polymer, of:
      88.2% of polyethylene glycol of molecular weight equal to 10,000 g/mole,
      6.0% isophorone di-isocyanate,
      5.8% of a linear alcohol having 14 carbon atoms,
   15.90% by weight of water,
   21.99% by weight of an ethoxylated non-ionic surfactant which is a blend of fatty alcohols having 12 to 18 carbon atoms on the fatty chain, and comprising 7 ethylene oxide units,
   4.44% by weight of an ethoxylated non-ionic surfactant which is a blend of fatty alcohols having 12 to 18 carbon atoms on the fatty chain, and comprising 3 ethylene oxide units,
   40.02% by weight of an ethoxylated non-ionic surfactant which is a blend of fatty alcohols having 8 carbon atoms on the fatty chain, and comprising 35 ethylene oxide units.
The thickening compound thus produced is clear.

Acidic Aqueous Formulation
This thickening compound is used to thicken an acidic aqueous formulation, which contains, expressed as a percentage by weight of the constituents relative to the total weight of the formulation:
   3% of citric acid,
   4.45% of the above-mentioned thickening compound,
   92.55% of water in addition to the water already present in the thickening compound.

The pH of the acidic aqueous formulation is less than 2.

The acidic aqueous formulation thus produced proves to be clear.

### Test No. 14

This test illustrates the invention.

Thickening Compound
The test uses a thickening compound consisting of, expressed as a percentage by weight of the constituents relative to the total weight of the compound:
   17.65% of a polyurethane thickening agent consisting, expressed as a percentage by weight of the different monomers relative to the total weight of the polymer, of:
      88.2% of polyethylene glycol of molecular weight equal to 10,000 g/mole,
      6.0% isophorone di-isocyanate,
      5.8% of a linear alcohol having 14 carbon atoms,
   15.90% by weight of water,
   21.99% by weight of an ethoxylated non-ionic surfactant which is a blend of fatty alcohols having 12 to 18 carbon atoms on the fatty chain, and comprising 7 ethylene oxide units,
   4.44% by weight of an ethoxylated non-ionic surfactant which is a blend of fatty alcohols having 12 to 18 carbon atoms on the fatty chain, and comprising 3 ethylene oxide units,
   40.02% by weight of an ethoxylated non-ionic surfactant which is a blend of fatty alcohols having 8 carbon atoms on the fatty chain, and comprising 35 ethylene oxide units.
The thickening compound thus produced is clear.

Acidic Aqueous Formulation
This thickening compound is used to thicken an acidic aqueous formulation, which contains, expressed as a percentage by weight of the constituents relative to the total weight of the formulation:
   3% of citric acid,
   4.5% of the above-mentioned thickening compound,
   92.5% of water in addition to the water already present in the thickening compound.

The pH of the acidic aqueous formulation is less than 2.

The acidic aqueous formulation thus produced proves to be clear.

### Test No. 15

This test illustrates the invention.

Thickening Compound
The test uses a thickening compound consisting of, expressed as a percentage by weight of the constituents relative to the total weight of the compound:
   17.65% of a polyurethane thickening agent consisting, expressed as a percentage by weight of the different monomers relative to the total weight of the polymer, of:
      86.6% of polyethylene glycol of molecular weight equal to 10,000 g/mole,
      6.7% isophorone di-isocyanate,
      6.7% of a linear alcohol having 14 carbon atoms,
   15.90% by weight of water,
   21.99% by weight of an ethoxylated non-ionic surfactant which is a blend of fatty alcohols having 12 to 18 carbon atoms on the fatty chain, and comprising 7 ethylene oxide units,
   4.44% by weight of an ethoxylated non-ionic surfactant which is a blend of fatty alcohols having 12 to 18 carbon atoms on the fatty chain, and comprising 3 ethylene oxide units,
   40.02% by weight of an ethoxylated non-ionic surfactant which is a blend of fatty alcohols having 8 carbon atoms on the fatty chain, and comprising 35 ethylene oxide units.
The thickening compound thus produced is clear.

Acidic Aqueous Formulation
This thickening compound is used to thicken an acidic aqueous formulation, which contains, expressed as a percentage by weight of the constituents relative to the total weight of the formulation:
   3% of citric acid,
   5.7% of the above-mentioned thickening compound,
   91.2% of water in addition to the water already present in the thickening compound.

The pH of the acidic aqueous formulation is less than 2.

The acidic aqueous formulation thus produced proves to be clear.

### Test No. 16

This test illustrates the invention.

Thickening Compound
The test uses a thickening compound consisting of, expressed as a percentage by weight of the constituents relative to the total weight of the compound:
   17.65% of a polyurethane thickening agent consisting, expressed as a percentage by weight of the different monomers relative to the total weight of the polymer, of:
      86.6% of polyethylene glycol of molecular weight equal to 10,000 g/mole,
      6.7% isophorone di-isocyanate,
      6.7% of a linear alcohol having 14 carbon atoms,
   15.90% by weight of water,
   21.99% by weight of an ethoxylated non-ionic surfactant which is a blend of fatty alcohols having 12 to 18 carbon atoms on the fatty chain, and comprising 7 ethylene oxide units,
   4.44% by weight of an ethoxylated non-ionic surfactant which is a blend of fatty alcohols having 12 to 18 carbon atoms on the fatty chain, and comprising 3 ethylene oxide units,
   40.02% by weight of an ethoxylated non-ionic surfactant which is a blend of fatty alcohols having 8 carbon atoms on the fatty chain, and comprising 35 ethylene oxide units.
The thickening compound thus produced is clear.

Acidic Aqueous Formulation
This thickening compound is used to thicken an acidic aqueous formulation, which contains, expressed as a percentage by weight of the constituents relative to the total weight of the formulation:
   3% of citric acid,
   4.5% of the above-mentioned thickening compound,
   92.5% of water in addition to the water already present in the thickening compound.

The pH of the acidic aqueous formulation is less than 2.

The acidic aqueous formulation thus produced proves to be clear.

All the results concerning the tests No. 1 to 16 are shown in table 1.

TABLE 1
characteristics of the thickening aqueous compounds and of the acidic aqueous
formulations

| | | acidic aqueous | | | | | | |
|---|---|---|---|---|---|---|---|---|
| | | formulation | | | | | | |
| | | (quantity of | | | | | | |
| | | constituents in | | | | | | |
| | | % by weight relative | | | | appearance | | R = |
| | | to the total acidic | | | appearance | of the | Brookfield ™ | Brookfield ™ |
| | | aqueous formulation | | | of the | acidic | viscosity of | viscosity/ |
| | | weight) | | | thickening | aqueous | the | mass of the |
| test | prior art/ | citric | thickening | | compound | formulation | formulation | thickening |
| No. | invention | acid | compound | water | clear/cloudy | clear/cloudy | (mPa · s) | compound |
| 1 | prior art | 3 | 14.0 | 83.0 | cloudy | cloudy | 30 | 2 |
| 2 | prior art | 3 | 14.1 | 82.9 | cloudy | cloudy | 275 | 20 |
| 3 | prior art | 3 | 13.6 | 83.4 | cloudy | cloudy | 25 | 2 |
| 4 | prior art | 3 | 10.4 | 86.6 | cloudy | cloudy | 525 | 50 |
| 5 | invention | 3 | 9.1 | 87.9 | clear | clear | 875 | 96 |
| 6 | invention | 3 | 9.1 | 87.9 | clear | clear | 650 | 71 |
| 7 | invention | 3 | 9.1 | 87.9 | clear | clear | 1200 | 132 |
| 8 | invention | 3 | 9.1 | 91.3 | clear | clear | 1400 | 154 |
| 9 | invention | 3 | 9.1 | 91.3 | clear | clear | 1550 | 170 |
| 10 | invention | 3 | 5.7 | 91.3 | clear | clear | 830 | 146 |
| 11 | invention | 3 | 4.35 | 92.7 | clear | clear | 290 | 67 |
| 12 | invention | 3 | 4.4 | 92.6 | clear | clear | 360 | 82 |
| 13 | invention | 3 | 4.45 | 92.6 | clear | clear | 410 | 92 |
| 14 | invention | 3 | 4.5 | 92.5 | clear | clear | 470 | 104 |
| 15 | invention | 3 | 5.7 | 91.3 | clear | clear | 870 | 153 |
| 16 | invention | 3 | 4.5 | 92.5 | clear | clear | 400 | 89 |

A reading of table 1 demonstrates that the thickening aqueous compounds of the prior art do not satisfy the skilled man in the art: they are all cloudy, and the same goes for the acidic aqueous formulations which contain them; furthermore, their thickening effect is weak, as is reflected in the values of the R ratio, which are all below 50.

Conversely, the thickening aqueous compounds according to the invention, which are notably based on a particular choice of surfactants and of polyurethane compounds, have a clear character, as do the acidic aqueous formulations which contain them. In addition, the thickening effect obtained is far superior to the one measured for the prior art, since the values of R are all over 50 in the case of the invention.

### Example 2

This example illustrates the use of a thickening aqueous compound according to the invention, with a view to thickening an acidic aqueous formulation containing citric acid or oxygenated water.

This example also illustrates the thickening aqueous compounds according to the invention, and the acidic aqueous formulations according to the invention.

For the tests No. 17 and 18, one commences by evaluating visually the clear or cloudy character of each thickening compound, and of each acidic aqueous formulation. Lastly, the Brookfield™ viscosity of each acidic aqueous formulation is measured, at 25° C. and at 10 rpm with module No. 3 (according to the method well known to the skilled man in the art) at instant t=0. the same measurement is made at instant t=28 days.

### Test No. 17

This test illustrates the invention.

Thickening Compound
The test uses a thickening compound consisting of, expressed as a percentage by weight of the constituents relative to the total weight of the compound:
   17.65% of a polyurethane thickening agent consisting, expressed as a percentage by weight of the different monomers relative to the total weight of the polymer, of:
      86.6% of polyethylene glycol of molecular weight equal to 10,000 g/mole,
      6.7% isophorone di-isocyanate,
      6.7% of a linear alcohol having 14 carbon atoms,
   15.90% by weight of water,
   21.99% by weight of an ethoxylated non-ionic surfactant which is a blend of fatty alcohols having 12 to 18 carbon atoms on the fatty chain, and comprising 7 ethylene oxide units,
   4.44% by weight of an ethoxylated non-ionic surfactant which is a blend of fatty alcohols having 12 to 18 carbon atoms on the fatty chain, and comprising 3 ethylene oxide units,
   40.02% by weight of an ethoxylated non-ionic surfactant which is a blend of fatty alcohols having 8 carbon atoms on the fatty chain, and comprising 35 ethylene oxide units.
The thickening compound thus produced is clear.

Acidic Aqueous Formulation
This thickening compound is used to thicken an acidic aqueous formulation, which contains, expressed as a percentage by weight of the constituents relative to the total weight of the formulation:
   10% of citric acid,
   10.4% of the above-mentioned thickening compound,
   79.6% of water in addition to the water already present in the thickening compound.

The pH of the acidic aqueous formulation is less than 2.

The acidic aqueous formulation thus produced proves to be clear.

The Brookfield™ viscosity of the aqueous formulation, at 25° C. and at 10 rpm with module No. 3 (according to the method well known to the skilled man in the art) is equal to:
1275 mPa·s at instant t=0
1200 mPa·s at instant t=28 days

This test thus demonstrates that the aqueous compound according to the invention enables the acidic aqueous formulation to be thickened effectively, whilst maintaining its clear character.

Moreover, this test also demonstrates that the thickening effect can be maintained over time, thanks to the thickening aqueous compound according to the invention.

### Test No. 18

This test illustrates the invention.

Thickening Compound
The test uses a thickening compound consisting of, expressed as a percentage by weight of the constituents relative to the total weight of the compound:
   17.65% of a polyurethane thickening agent consisting, expressed as a percentage by weight of the different monomers relative to the total weight of the polymer, of:
      86.6% of polyethylene glycol of molecular weight equal to
      6.7% isophorone di-isocyanate,
      6.7% of a linear alcohol having 14 carbon atoms,
   15.90% by weight of water,
   21.99% by weight of an ethoxylated non-ionic surfactant which is a blend of fatty alcohols having 12 to 18 carbon atoms on the fatty chain, and comprising 7 ethylene oxide units,
   4.44% by weight of an ethoxylated non-ionic surfactant which is a blend of fatty alcohols having 12 to 18 carbon atoms on the fatty chain, and comprising 3 ethylene oxide units,
   40.02% by weight of an ethoxylated non-ionic surfactant which is a blend of fatty alcohols having 8 carbon atoms on the fatty chain, and comprising 35 ethylene oxide units.
The thickening compound thus produced is clear.

Acidic Aqueous Formulation
This thickening compound is used to thicken an acidic aqueous formulation, which contains, expressed as a percentage by weight of the constituents relative to the total weight of the formulation:
   21.1% of oxygenated water,
   11.0% of the above-mentioned thickening compound,
   0.5% of 1-hydroxy ethylene 1,1 di-phosphonic acid used as a stabilising agent of oxygenated water
   67.6% of water in addition to the water already present in the thickening compound.

The pH of the acidic aqueous formulation is less than 3.

The acidic aqueous formulation thus produced proves to be clear.

The Brookfield™ viscosity of the aqueous formulation, at 25° C. and at 10 rpm with module No. 3 (according to the method well known to the skilled man in the art) is equal to:
2100 mPa·s at instant t=0
1800 mPa·s at instant t=28 days

This test thus demonstrates that the aqueous compound according to the invention enables the acidic aqueous formulation to be thickened effectively, whilst maintaining its clear character.

Moreover, this test also demonstrates that the thickening effect can be maintained over time, thanks to the thickening aqueous compound according to the invention.

### Example 3

Tests No. 19 to 23 which illustrate the invention use a thickening composition consisting, expressed as a percentage by weight of the constituents relative to the total weight of the composition, of:
17.65% of a polyurethane thickening agent consisting, expressed as a percentage by weight of the different monomers relative to the total weight of the polymer, of:
   81.5% of polyethylene glycol of molecular weight equal to 6,000 g/mole,
   6.7% isophorone di-isocyanate,
   6.7% of a linear alcohol having 12 carbon atoms,
15.90% by weight of water,
21.99% by weight of an ethoxylated non-ionic surfactant which is a blend of fatty alcohols having 12 to 18 carbon atoms on the fatty chain, and comprising 7 ethylene oxide units,
4.44% by weight of an ethoxylated non-ionic surfactant which is a blend of fatty alcohols having 12 to 18 carbon atoms on the fatty chain, and comprising 3 ethylene oxide units,
40.02% by weight of an ethoxylated non-ionic surfactant which is a blend of fatty alcohols having 8 carbon atoms on the fatty chain, and comprising 35 ethylene oxide units.

The thickening composition thus produced is clear.

This thickening composition is used to thicken different acidic aqueous formulations, the nature of which is given in table 2.

This table also indicates the value of the Brookfield™ viscosity of each acidic aqueous formulation, at 25° C. and at 10 rpm with module No. 3 (according to the method well known to the skilled man in the art), together with its clear or cloudy character.

TABLE 2
acidic aqueous formulations with:

| | test No. | | | | |
|---|---|---|---|---|---|
| | 19 | 20 | 21 | 22 | 23 |
| thickening | 9.1 | 7.65 | 9.1 | 6.5 | 7.88 |
| composition | | | | | |
| acid | 3 | 3 | 3 | 3 | 3 |
| | (citric) | (boric) | (formic) | (lactic) | (HEDP) |
| water | 87.9 | 89.35 | 87.9 | 90.5 | 89.12 |
| Brookfield viscosity | 740 | 310 | 520 | 125 | 320 |
| at 10 rpm (mPa · s) | | | | | |
| appearance | clear | clear | clear | clear | clear |

quantity of each constituent, expressed as a percentage by weight relative to the total weight of the formulation
nature of the acid used (between parentheses)
HEDP: 1-hydroxy ethylene-1,1-diphosphonic acid

These tests thus demonstrate that the aqueous compositions according to the invention enable the acidic aqueous formulations to be thickened effectively, whilst maintaining their clear character.

### Example 4

Tests No. 24 to 27 which illustrate the invention use a thickening composition consisting, expressed as a percentage by weight of the constituents relative to the total weight of the composition, of:
30.0% of a polyurethane thickening agent consisting, expressed as a percentage by weight of the different monomers relative to the total weight of the polymer, of:
   81.5% of polyethylene glycol of molecular weight equal to 6,000 g/mole,
   6.7% isophorone di-isocyanate,
   6.7% of a linear alcohol having 12 carbon atoms,
20.0% by weight of water,
20.0% by weight of an ethoxylated non-ionic surfactant which is a blend of fatty alcohols having 9 carbon atoms on the fatty chain, and comprising 115 ethylene oxide units.
30.0% by weight of an ethoxylated non-ionic surfactant which is a blend of fatty alcohols having 8 carbon atoms on the fatty chain, and comprising 35 ethylene oxide units.

The thickening composition thus produced is clear.

This thickening composition is used to thicken different acidic aqueous formulations, the nature of which is given in table 3.

This table also indicates the value of the Brookfield™ viscosity of each acidic aqueous formulation, at 25° C. and at 10 rpm with module No. 3 (according to the method well known to the skilled man in the art), together with its clear or cloudy character.

TABLE 3
acidic aqueous formulations with:

| | test No. | | | |
|---|---|---|---|---|
| | 24 | 25 | 26 | 27 |
| thickening | 9.1 | 6.47 | 8 | 6 |
| composition | | | | |
| acid | 3 | 3 | 3 | 3 |
| | (phosphoric) | (citric) | (nitric) | (acetic) |
| water | 87.9 | 90.53 | 89 | 91 |
| Brookfield viscosity | 2500 | 240 | 680 | 160 |
| at 10 rpm (mPa · s) | | | | |
| appearance | clear | clear | clear | clear |

quantity of each constituent, expressed as a percentage by weight relative to the total weight of the formulation
nature of the acid used (between parentheses)

These tests thus demonstrate that the aqueous compositions according to the invention enable the acidic aqueous formulations to be thickened effectively, whilst maintaining their clear character.

### Example 5

Tests No. 28 to 29 which illustrate the invention use a thickening composition consisting, expressed as a percentage by weight of the constituents relative to the total weight of the composition, of:
25.0% of a polyurethane thickening agent consisting, expressed as a percentage by weight of the different monomers relative to the total weight of the polymer, of:
   81.5% of polyethylene glycol of molecular weight equal to 6,000 g/mole,
   6.7% isophorone di-isocyanate,
   6.7% of a linear alcohol having 12 carbon atoms,
31.0% by weight of water,
25.0% by weight of an ethoxylated non-ionic surfactant which is a blend of fatty alcohols having 8 carbon atoms on the fatty chain, and comprising 35 ethylene oxide units,
15.0% by weight of an ethoxylated non-ionic surfactant which is a blend of fatty alcohols having 14 to 15 carbon atoms on the fatty chain, and comprising 7 ethylene oxide units,
4.0% by weight of an ethoxylated non-ionic surfactant which is a blend of fatty alcohols having 12 to 18 carbon atoms on the fatty chain, and comprising 3 ethylene oxide units.

The thickening composition thus produced is clear.

This thickening composition is used to thicken different acidic aqueous formulations, the nature of which is given in table 4.

This table also indicates the value of the Brookfield™ viscosity of each acidic aqueous formulation, at 25° C. and at 10 rpm with module No. 3 (according to the method well known to the skilled man in the art), together with its clear or cloudy character.

TABLE 4
acidic aqueous formulations with:

test No.

| | 28 | 29 |
|---|---|---|
| thickening | 11.98 | 9.4 |
| composition | | |
| acid | 3 | 3 |
| | (PBTC) | (hydrochloric) |
| water | 85.02 | 87.6 |
| Brookfield viscosity | 1540 | 400 |
| at 10 rpm (mPa · s) | | |
| appearance | clear | clear |

quantity of each constituent, expressed as a percentage by weight relative to the total weight of the formulation
nature of the acid used (between parentheses)
PBTC: 2-phosphonobutane-1,2,4-tricarboxylic acid

These tests thus demonstrate that the aqueous compositions according to the invention enable the acidic aqueous formulations to be thickened effectively, whilst maintaining their clear character.

### Example 6

Tests No. 30 to 33 which illustrate the invention use a thickening composition consisting, expressed as a percentage by weight of the constituents relative to the total weight of the composition, of:
10.0% of a polyurethane thickening agent consisting, expressed as a percentage by weight of the different monomers relative to the total weight of the polymer, of:
   93.7% of polyethylene glycol of molecular weight equal to 20,000 g/mole,
   3.43% isophorone di-isocyanate,
   2.87% of a linear alcohol having 12 carbon atoms,
20.0% by weight of water,
40.0% by weight of an ethoxylated non-ionic surfactant which is a blend of fatty alcohols having 8 to 10 carbon atoms on the fatty chain, and comprising 100 ethylene oxide units and 5 propylene oxide units,
30.0% by weight of an ethoxylated non-ionic surfactant which is a blend of fatty alcohols having 12 to 15 carbon atoms on the fatty chain, and comprising 7 ethylene oxide units.

The thickening composition thus produced is clear.

This thickening composition is used to thicken different acidic aqueous formulations, the nature of which is given in table 5.

This table also indicates the value of the Brookfield™ viscosity of each acidic aqueous formulation, at 25° C. and at 10 rpm with module No. 3 (according to the method well known to the skilled man in the art), together with its clear or cloudy character.

TABLE 5
acidic aqueous formulations with:

| test No. | 30 | 31 | 32 | 33 |
|---|---|---|---|---|
| thickening | 16 | 9.1 | 16.15 | 9.3 |
| composition | | | | |
| acid | 3 | 3 | 3 | (7.4) |
| | (citric) | (oxalic) | (succinic) | oxygenated |
| | | | | water* |
| water | 81 | 87.9 | 80.85 | 83.16 |
| Brookfield viscosity | 270 | 312 | 204 | 2060 |
| at 10 rpm (mPa · s) | | | | |
| appearance | clear | clear | clear | clear |

quantity of each constituent, expressed as a percentage by weight relative to the total weight of the formulation
nature of the acid used (between parentheses)
*the oxygenated water is stabilised with 0.14% by weight (relative to the total weight of the formulation) of hydroxy ethylene-1,1-diphosphonic acid

These tests thus demonstrate that the aqueous compositions according to the invention enable the acidic aqueous formulations to be thickened effectively, whilst maintaining their clear character.

### Example 7

Tests No. 34 to 36 which illustrate the invention use a thickening composition consisting, expressed as a percentage by weight of the constituents relative to the total weight of the composition, of:
17.65% of a polyurethane thickening agent consisting, expressed as a percentage by weight of the different monomers relative to the total weight of the polymer, of:
   93.7% of polyethylene glycol of molecular weight equal to 20,000 g/mole,
   3.43% isophorone di-isocyanate,
   2.87% of a linear alcohol having 12 carbon atoms,
35.91% by weight of water,
20.0% by weight of an ethoxylated non-ionic surfactant which is a blend of fatty alcohols having 8 carbon atoms on the fatty chain, and comprising 35 ethylene oxide units,
22.0% by weight of an ethoxylated non-ionic surfactant which is a blend of fatty alcohols having 12 to 18 carbon atoms on the fatty chain, and comprising 7 ethylene oxide units,
4.44% by weight of an ethoxylated non-ionic surfactant which is a blend of fatty alcohols having 12 to 18 carbon atoms on the fatty chain, and comprising 3 ethylene oxide units.

The thickening composition thus produced is clear.

This thickening composition is used to thicken different acidic aqueous formulations, the nature of which is given in table 6.

This table also indicates the value of the Brookfield™ viscosity of each acidic aqueous formulation, at 25° C. and at 10 rpm with module No. 3 (according to the method well known to the skilled man in the art), together with its clear or cloudy character.

TABLE 6
acidic aqueous formulations with:

| test No. | 34 | 35 | 36 |
|---|---|---|---|
| thickening | 15.35 | 18.82 | 17 |
| composition | | | |
| acid | 3 | 3 | 3 |
| | (EDTMP) | (itaconic) | (sulphuric) |
| water | 81.65 | 78.18 | 80 |
| Brookfield viscosity | 80 | 40 | 60 |
| at 10 rpm (mPa · s) | | | |
| appearance | clear | clear | clear |

quantity of each constituent, expressed as a percentage by weight relative to the total weight of the formulation
nature of the acid used (between parentheses)
EDTMP: ethylene diamine tetramethyl phosphonic

These tests thus demonstrate that the aqueous compositions according to the invention enable the acidic aqueous formulations to be thickened effectively, whilst maintaining their clear character.

1-16. (canceled)

17. Thickening and clear aqueous compounds, characterised in that they comprise, expressed as a percentage by weight of each constituent, relative to the total weight of the formulation:
(a) between 10% and 80%, and preferentially between 20% and 65%, of at least 2 non-ionic surfactants,
(b) between 4% and 40%, and preferentially between 10% and 30%, of at least 1 polyurethane compound, consisting of at least one grouping of the alkyl or aryl or aryalkyl type, or a blend of these groupings, of at least one grouping of the polyalkylene glycol type, which is preferentially polyethylene glycol, and of at least one isocyanate grouping chosen from among:
the monoisocyanates, and notably 1-decyl isocyanate, 1-dodecyl isocyanate, mirystyl isocyanate, palmityl isocyanate, stearyl isocyanate,
the diisocyanates, and notably 1,4-butane diisocyanate, 1,6-hexane diisocyanate, the cycloaliphatic diisocyanates, and notably isophorone di-isocyanate, 1,3- and 1,4-cyclohexane diisocyanate, 4,4′ diisocyanatodicyclohexylmethane, 1-methyl-2,4-diisocyanatocyclohexane and its blend with 1-methyl-2,6-diisocyanatocyclohexane,
the triisocyanates, and notably hexamethylene diisocyanate biuret, hexamethylene diisocyanate trimer, isophorone diisocyanate trimer,
and their blends,
(c) and the remainder of water.

18. Thickening and clear aqueous compounds according to claim 17, characterised in that, in respect of the surfactants they use, the said surfactants are non-ionic oxyalkylated fatty alcohols, preferentially having 3 to 40 oxyethylene units, and preferentially having 8 to 30 carbon atoms, and very preferentially 8 to 20 carbon atoms.

19. Thickening and clear aqueous compounds according to claim 17, characterised in that, in respect of the polyurethanes which they use, the groupings of the alkyl or aryl or aryalkyl type, of a blend of these groupings, are preferentially fatty alcohols, with these fatty alcohols preferentially having 8 to 20 carbon atoms, very preferentially 10 to 18 carbon atoms, and extremely preferentially 10 to 16 carbon atoms.

20. Thickening and clear aqueous compounds according to claim 17, characterised in that, in respect of the polyurethanes which they use, the polyalkylene glycol groupings have a molecular weight of between 5,000 g/mole and 20,000 g/mole, and preferentially between 8,000 g/mole and 15,000 g/mole, and very preferentially between 8,000 g/mole and 12,000 g/mole.

21. Thickening and clear aqueous compounds according to claim 17, characterised in that, in respect of the polyurethanes which they use, the isocyanate groupings are chosen from among the diisocyanates, and notably 1,4-butane di-isocyanate, 1,6-hexane diisocyanate, the cycloaliphatic diisocyanates, and notably isophorone diisocyanate, 1,3- and 1,4-cyclohexane diisocyanate, 4,4′ diisocyanatodicyclohexylmethane, 1-methyl-2,4-diisocyanatocyclohexane and its blend with 1-methyl-2,6-diisocyanatocyclohexane and their blends, and preferentially in that the isocyanate grouping is isophorone diisocyanate.

22. Acidic aqueous formulations comprising:
(a) at least 2 non-ionic surfactants,
(b) at least 1 polyurethane compound, consisting of at least one grouping of the alkyl or aryl or aryalkyl type, or a blend of these groupings, of at least one grouping of the polyalkylene glycol type, which is preferentially polyethylene glycol, and at least one particular isocyanate grouping chosen from among:
the monoisocyanates, and notably 1-decyl isocyanate, 1-dodecyl isocyanate, mirystyl isocyanate, palmityl isocyanate, stearyl isocyanate,
the diisocyanates, and notably 1,4-butane di-isocyanate, 1,6-hexane diisocyanate, the cycloaliphatic diisocyanates, and notably isophorone diisocyanate, 1,3- and 1,4-cyclohexane diisocyanate, 4,4′ diisocyanatodicyclohexylmethane, 1-methyl-2,4-diisocyanatocyclohexane and its blend with 1-methyl-2,6-diisocyanatocyclohexane,
the triisocyanates, and notably hexamethylene diisocyanate biuret, hexamethylene diisocyanate trimer, isophorone diisocyanate trimer,
and their blends,
(c) and water.

23. The acid acqueous formulations according to claim 22, characterised in that the said thickening and clear aqueous compounds comprise, expressed as a percentage by weight of each constituent, relative to the total weight of the formulation:
(a) between 10% and 80%, and preferentially between 20% and 65%, of at least 2 non-ionic surfactants,
(b) between 4% and 40%, and preferentially between 10% and 30%, of at least 1 polyurethane compound, consisting of at least one grouping of the alkyl or aryl or aryalkyl type, or a blend of these groupings, of at least one grouping of the polyalkylene glycol type, which is preferentially polyethylene glycol, and of at least one isocyanate grouping chosen from among:
the monoisocyanates, and notably 1-decyl isocyanate, 1-dodecyl isocyanate, mirystyl isocyanate, palmityl isocyanate, stearyl isocyanate,
the diisocyanates, and notably 1,4-butane di-isocyanate, 1,6-hexane diisocyanate, the cycloaliphatic diisocyanates, and notably isophorone diisocyanate, 1,3- and 1,4-cyclohexane diisocyanate, 4,4′ diisocyanatodicyclohexylmethane, 1-methyl-2,4-diisocyanatocyclohexane and its blend with 1-methyl-2,6-diisocyanatocyclohexane,
the triisocyanates, and notably hexamethylene diisocyanate biuret, hexamethylene diisocyanate trimer, isophorone diisocyanate trimer,
and their blends,
(c) and the remainder of water.

24. The acid acqueous formulations according to claim 22, characterised in that the thickening and clear aqueous compounds comprise at least 2 surfactants which are non-ionic oxyalkylated fatty alcohols, preferentially having 3 to 40 oxyethylene units, and preferentially having 8 to 30 carbon atoms, and very preferentially 8 to 20 carbon atoms.

25. The acid acqueous formulations according to claim 22, characterised in that the thickening and clear aqueous compounds comprise at least one polyurethane compound, the groupings of which of the alkyl or aryl or aryalkyl type, or a blend of these groupings, are preferentially fatty alcohols, with these fatty alcohols preferentially having 8 to 20 carbon atoms, very preferentially 10 to 18 carbon atoms, and extremely preferentially 10 to 16 carbon atoms.

26. The acid acqueous formulations according to claim 22, characterised in that the thickening and clear aqueous compounds comprise at least one polyurethane compound the polyethylene glycol groupings of which have a molecular weight of between 5,000 g/mole and 20,000 g/mole, and preferentially between 8,000 g/mole and 15,000 g/mole, and very preferentially between 8,000 g/mole and 12,000 g/mole.

27. The acid acqueous formulations according to claim 22, characterised in that the thickening and clear aqueous compounds comprise at least one polyurethane compound, the isocyanate groupings of which are chosen from among the diisocyanates, and notably 1,4-butane diisocyanate, 1,6-hexane di-isocyanate, the cycloaliphatic diisocyanates, and notably isophorone diisocyanate, 1,3- and 1,4-cyclohexane diisocyanate, 4,4′ diisocyanatodicyclohexylmethane, 1-methyl-2,4-diisocyanatocyclohexane and its blend with 1-methyl-2,6-diisocyanatocyclohexane and their blends, and preferentially in that the isocyanate grouping is isophorone diisocyanate.

28. The acid acqueous formulations according to claim 22, characterised in that use is made of between 2% and 50%, and preferentially between 4% and 20%, by weight of thickening and clear aqueous compound, relative to the total weight of the acidic aqueous formulation to be thickened.

29. The acid acqueous formulations according to claim 22, characterised in that the thickening and clear aqueous compound is used in an acidic aqueous formation containing at least one acidifier compound chosen notably from among the hydrochloric, phosphoric, sulphuric, nitric, sulphamic, acetic, boric, citraconic, citric, diglycolic, ethylene diamine tetra-acetic, hydrofluoric, formic, glucoheptonic, glutaric, glycolic, glyoxylic, isethionic, itaconic, lactic, maleic, malic, methane sulphonic, methylsuccinic, octylic, oxalic, peracetic, propionic, saccharic, succinic or valeric acids, or from among the phosphonic acids such as notably 1-hydroxyethane 1,1-diphosphonic acid, amino trimethylene phosphonic acid, ethylene diamine tetramethyl phosphonic acid, diethylene triamine pentamethyl phosphonic acid, hexamethylene diamine tetramethyl phosphonic acid, hydroxyethylamino dimethyl phosphonic acid, 2-phosphonobutane-1,2,4-tricarboxylic acid, or the blends of these acids, or again the blends of these acids with oxygenated water.

30. The acid acqueous formulations according to claim 22, characterised in that the thickening and clear aqueous compound is used in an acidic aqueous formulation, the pH of which is less than 7, preferentially less than 6, very preferentially less than 5, and even more preferentially less than 4.

31. Thickened acidic aqueous formulations the appearance of which is clear, characterised in that they comprise a thickening aqueous compound according to claim 17.
